(19) United States
(12) Patent Application Publication
(10) Pub. No.: US 2025/0165829 A1
(43) Pub. Date: May 22, 2025

(54) SIMULTANEOUS QUANTUM JOB EXECUTION WITH QUBIT ISOLATION

(71) Applicant: International Business Machines Corporation, Armonk, NY (US)

(72) Inventors: John S. Werner, Fishkill, NY (US); Youngseok Kim, Upper Saddle River, NJ (US); Sagarika Mukesh, Albany, NY (US); Arkadiy O. Tsfasman, Wappingers Falls, NY (US); Robert E. Loredo, North Miami Beach, FL (US)

(21) Appl. No.: 18/511,170

(22) Filed: Nov. 16, 2023

(51) Int. Cl. G06N 10/40

(52) U.S. Cl. CPC G06N 10/40

(57) ABSTRACT

Systems and techniques that facilitate simultaneous execution of multiple quantum jobs are provided. For example, embodiments described herein can comprise a system, which can comprise a memory that can store computer executable components. The system can also comprise a processor, operably coupled to the memory that can execute the computer executable components stored in memory. The computer executable components can comprise a scheduling component that determines a first set of qubits to execute a first quantum job on a quantum processor and a second set of qubits to execute a second quantum job, wherein the second set of qubits does not include the first set of qubits or a first set of idle qubits; and an isolation component that determines the first set of idle qubits, wherein the first set of idle qubits isolates the first set of qubits from crosstalk of other operations on the quantum processor.

### BACKGROUND

The subject disclosure relates to quantum circuit execution, and more specifically to simultaneous quantum job execution with qubit isolation.

### SUMMARY

The following presents a summary to provide a basic understanding of one or more embodiments of the invention. This summary is not intended to identify key or critical elements, or delineate any scope of the particular embodiments or any scope of the claims. Its sole purpose is to present concepts in a simplified form as a prelude to the more detailed description that is presented later. In one or more embodiments described herein, systems, devices and/or method that facilitate simultaneous quantum job execution with qubit isolation.

According to an embodiment, a system can comprise a processor that executes computer executable components stored in memory. The computer executable components comprise a scheduling component that determines a first set of qubits to execute a first quantum job on a quantum processor and a second set of qubits to execute a second quantum job, wherein the second set of qubits does not include the first set of qubits or a first set of idle qubits; and an isolation component that determines the first set of idle qubits, wherein the first set of idle qubits isolates the first set of qubits from crosstalk of other operations on the quantum processor. An advantage of such a system is that it allows for simultaneous execution of multiple quantum jobs on a quantum processor, thereby improving the speed at which quantum jobs can be performed on the quantum processor.

In some embodiments of the above describe system, the first quantum job and the second quantum job comprise identical quantum jobs. An advantage of such a system is that quantum jobs that call for repetitive execution can be executed multiple times simultaneously, thereby decreasing the overall number of quantum processor cycles used to execute a set number of iterations of the quantum job.

According to another embodiment, a computer-implemented method can comprise determining, by a system operatively coupled to a processor, a first set of qubits to execute a first quantum job on a quantum processor; determining, by the system, a first set of idle qubits corresponding to the first set of qubits, wherein the first set of idle qubits isolates the first set of qubits from crosstalk of other operations on the quantum processor; and determining, by the system, a second set of qubits to execute a second quantum job, wherein the second set of qubits does not include the first set of qubits or the first set of idle qubits. An advantage of such a method is that it allows for simultaneous execution of multiple quantum jobs on a quantum processor, thereby improving the speed at which quantum jobs can be performed on the quantum processor.

In some embodiments of the above-described method, the first quantum job and the second quantum job comprise identical quantum jobs. An advantage of such a method is that quantum jobs that call for repetitive execution can be executed multiple times simultaneously, thereby decreasing the overall number of quantum processor cycles used to execute a set number of iterations of the quantum job.

According to another embodiment, a computer program product comprising a computer readable storage medium having program instructions embodied therewith, the program instructions executable by a processor to cause the processor to determine, by the processor, a first set of qubits to execute a first quantum job on a quantum processor; determine, by the processor, a first set of idle qubits corresponding to the first set of qubits, wherein the first set of idle qubits isolates the first set of qubits from crosstalk of other operations on the quantum processor; and determine, by the processor, a second set of qubits to execute a second quantum job, wherein the second set of qubits does not include the first set of qubits or the first set of idle qubits. An advantage of such a computer program product is that it allows for simultaneous execution of multiple quantum jobs on a quantum processor, thereby improving the speed at which quantum jobs can be performed on the quantum processor.

In some embodiments of the above-described computer program product, the first quantum job and the second quantum job comprise identical quantum jobs. An advantage of such a method is that quantum jobs that call for repetitive execution can be executed multiple times simultaneously, thereby decreasing the overall number of quantum processor cycles used to execute a set number of iterations of the quantum job.

### DESCRIPTION OF THE DRAWINGS

FIG. 1 illustrates block diagram of an example, non-limiting system that can facilitate simultaneous quantum job execution in accordance with one or more embodiments described herein.

FIGS. 2A-2C illustrate diagrams of various use cases of simultaneous quantum job execution in accordance with one or more embodiments described herein.

FIG. 3 illustrates a diagram showing qubit utilization of an example quantum processor in accordance with one or more embodiments described herein.

FIGS. 4A and 4B illustrate a comparison of single quantum job scheduling and quantum scheduling for simultaneous execution as described herein.

FIG. 5 illustrates a flow diagram of an example, non-limiting, computer-implemented method that can facilitate scheduling of quantum jobs for simultaneous execution in accordance with one or more embodiments described herein.

FIG. 6 illustrates a block diagram of a cloud network system that can facilitate scheduling and simultaneous execution of quantum circuits in accordance with one or more embodiments described herein.

FIG. 7 illustrates a flow diagram of an example, non-limiting, computer-implemented method that can facilitate scheduling of quantum jobs for simultaneous execution in accordance with one or more embodiments described herein.

FIG. 8 illustrates a flow diagram of an example, non-limiting, computer-implemented method that can facilitate scheduling of pulses for simultaneous quantum job execution in accordance with one or more embodiments described herein.

FIG. 9 illustrates a block diagram of an example, non-limiting system that can complete execution of a quantum job in accordance with one or more embodiments described herein.

FIG. 10 illustrates an example, non-limiting environment for the execution of at least some of the computer code in accordance with one or more embodiments described herein.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section.

Quantum computing is generally the use of quantum-mechanical phenomena for the purpose of performing computing and information processing functions. Quantum computing can be viewed in contrast to classical computing, which generally operates on binary values with transistors. That is, while classical computers can operate on bit values that are either 0 or 1, quantum computers operate on quantum bits (qubits) that comprise superpositions of both 0 and 1, can entangle multiple quantum bits, and use interference.

As demand for quantum computing increases, larger and more powerful (e.g., with increasing number of qubits) quantum processors are being developed in order to meet demand. However, with increasing number of qubits, there is an understanding that execution of quantum jobs (e.g., quantum circuits and/or monitoring jobs) will not always call for the use of the entire quantum processor. For example, some jobs may only use a fraction of the qubits in larger quantum processors. Furthermore, noise from neighboring qubits may negatively impact the performance of qubits utilized to execute circuits. Accordingly, there is a demand for better utilization of whole quantum processors while also isolating quantum circuits from noise from neighboring qubits.

In one or more embodiments, the present disclosure can be implemented in the form of systems, computer-implemented methods, and/or computer program products that can address the above identified issues by identifying a first set of qubits to execute a first quantum job on a quantum processor, determining a first set of idle qubits corresponding to the first set of qubits, wherein the first set of idle qubits isolates the first set of qubits from crosstalk of other operations on the quantum processor, and determining a second set of qubits to execute a second quantum job, wherein the second set of qubits does not include the first set of qubits or the first set of idle qubits.

As referenced herein, an “entity” can comprise a human, a client, a user, a computing device, a software application, an agent, a machine learning (ML) model, an artificial intelligence (AI) model, and/or another entity.

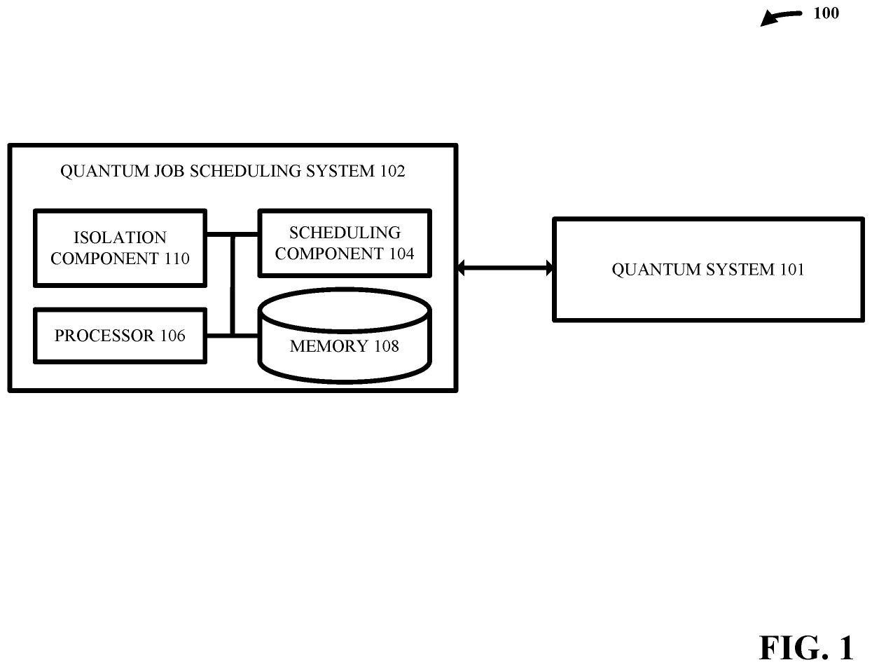

FIG. 1 illustrates a block diagram of an example, non-limiting system 100 that can facilitate simultaneous quantum job execution in accordance with one or more embodiments described herein. Aspects of systems (e.g., system 102 and the like), apparatuses or processes in various embodiments of the present invention can constitute one or more machine-executable components embodied within one or more machines (e.g., embodied in one or more computer readable mediums (or media) associated with one or more machines). Such components, when executed by the one or more machines (e.g., computers, computing devices, virtual machines, etc.) can cause the machines to perform the operations described. System 102 can comprise isolation component 110, scheduling component 104, processor 106, memory 108 and quantum system 101.

In various embodiments, quantum job scheduling system 102 can comprise a processor 106 (e.g., a computer processing unit, microprocessor) and a computer-readable memory 108 that is operably connected to the processor 106. The memory 108 can store computer-executable instructions which, upon execution by the processor, can cause the processor 106 and/or other components of the quantum job scheduling system 102 (e.g., isolation component 110, scheduling component 104, processor 106, memory 108, and/or quantum system 101) to perform one or more acts. In various embodiments, the memory 108 can store computer-executable components (e.g., isolation component 110, scheduling component 104, processor 106, memory 108, and/or quantum system 101), the processor 106 can execute the computer-executable components.

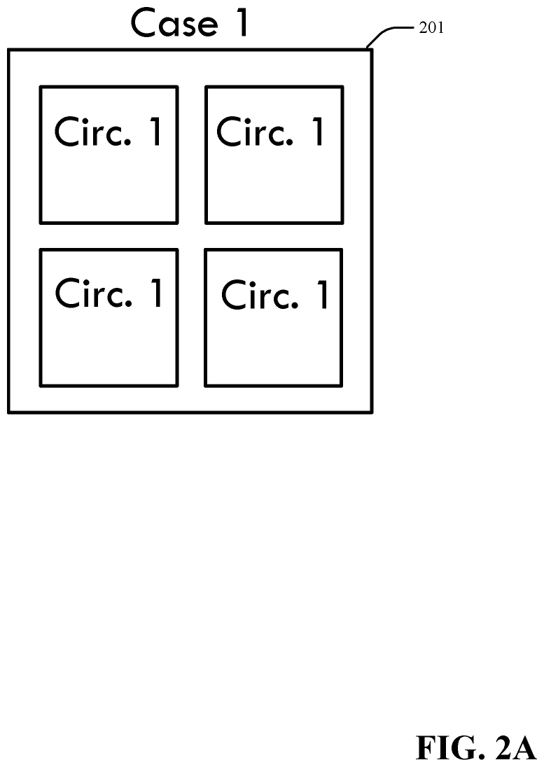

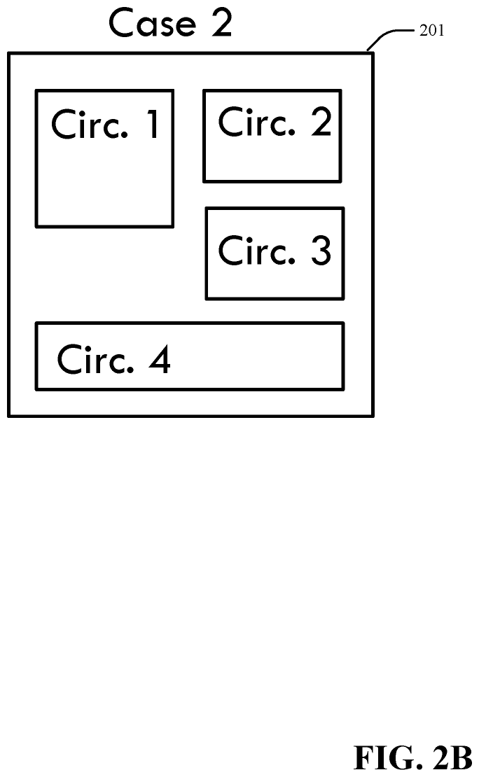

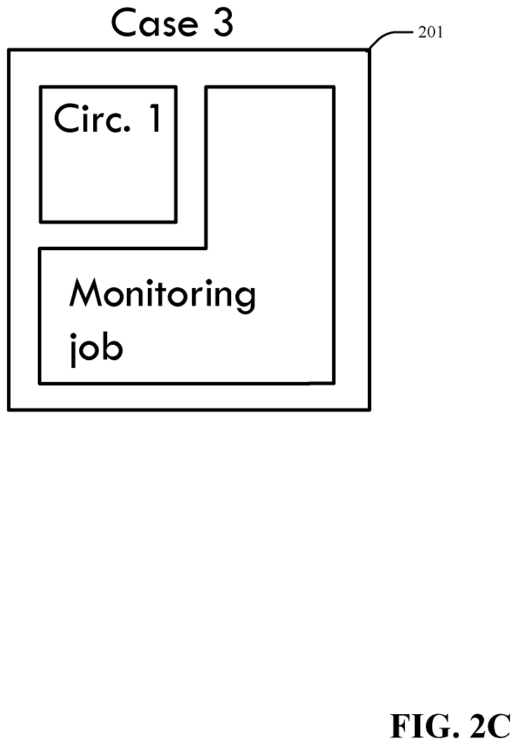

In one or more embodiments, scheduling component 104 can identify one or more quantum jobs for simultaneous execution on a quantum processor. For example, scheduling component 104 can identify a first quantum job, a second quantum job, a third quantum job, etc. from a list of quantum jobs for execution from one or more entities. In some embodiments, the multiple quantum jobs can comprise identical copies of the same quantum circuit (referred to herein as Case 1). For example, often quantum circuits are executed multiple iterations (alternatively referred to as shots). Accordingly, in some cases rather than executing a quantum circuit for 1000 iterations, multiple copies of the quantum circuit can be executed simultaneously on the same quantum processor in order to decrease the overall runtime of the quantum processor. Turning to FIG. 2A, a diagram of Case 1 is provided. As shown quantum processor 201 can run four copies of circuit 1 simultaneously. Therefore, if circuit 1 is to be executed for 1000 iterations, quantum processor 201 can execute the four copies of circuit 1 250 times. Therefore, circuit 1 is still executed 1000 times (e.g., four multiplied by 250), but the overall runtime for quantum processor 201 has been reduced to 250 iterations. Accordingly, for Case 1, the overall runtime of a quantum job can be reduced to the number of iterations a quantum circuit is specified to run for divided by the number of copies of the quantum circuit that can be simultaneously executed on the quantum processor.

Returning to FIG. 1, in an embodiment, the multiple quantum jobs can comprise different quantum circuits and/or quantum tasks. For example, multiple different quantum circuits can be executed on the quantum processor simultaneously (referred to as Case 2). In another example, one or more quantum circuits and one or more monitoring jobs can be executed simultaneously (referred to as Case 3). As utilized herein, monitoring jobs can refer to any quantum circuit or operation that is run on a quantum processor in order to verify that the quantum processor is operating within acceptable performance parameters. FIG. 2B illustrates a diagram of a quantum processor for Case 2. As shown, circuits 1, 2, 3 and 4 have all been selected for simultaneous execution on quantum processor 201. By executing multiple circuits simultaneously, the overall runtime of quantum processor 201 can be decreased. FIG. 2C illustrates a diagram of a quantum processor for Case 3. As shown, circuit 1 and a monitoring job can be executed simultaneously, thereby decreasing overall runtime of quantum processor 201. Once one or more quantum jobs are identified and/or selected, scheduling component 104 can then determine a set of qubits of the quantum processor that will execute the quantum job. In one or more embodiments, the qubits can be selected based on the requirements of the quantum job, performance history of the quantum processor, coherence times, gate fidelity, calibration data and other characteristics of the quantum job and/or the quantum processor. Furthermore, it should be appreciated that in one or more embodiments, combinations of Case 1, Case 2, and Case 3 are envisioned. For example, a first quantum job and a second job that are copies of the same quantum circuit can be executed simultaneously to a third quantum job comprising a different quantum circuit.

In one or more embodiments, isolation component 110 can determine sets of idle qubits corresponding to sets of qubits determined by scheduling component 104 for execution of one or more quantum jobs. For example, given a first set of qubits that are selected to execute a first quantum job, isolation component 110 can select a first set of idle qubits that will isolate the first set of qubits from other qubits executing other quantum jobs on the quantum processor. In some embodiments, scheduling component 104 can identify a first quantum job and a first set of qubits to execute the quantum job. The isolation component 110 can then determine the first set of idle qubits that isolates the first set of qubits. The scheduling component 104 can then determine a second quantum job and second set of qubits to execute the second quantum job, wherein the second set of qubits does not include the first set of qubits or the first idle set of qubits. Quantum job scheduling system 102 can then continue determining additional sets of isolation qubits, quantum jobs, and sets of qubits for execution of the quantum jobs until no quantum jobs can fit onto the quantum processor. The scheduling component 104 can determine which quantum jobs to schedule and when to schedule them based on one or more factors. For example, scheduling component 104 can receive a queue of quantum jobs for performance by the quantum system 101. The first quantum job can be selected based on factors such as the next job in the queue or based on a priority level assigned by an entity requesting performance of the quantum job. Once the first quantum job has been selected and qubits for execution and isolation have been assigned, scheduling component 104 can search for and select one or more additional quantum jobs based on the availability of un-assigned qubits (e.g., those qubits not already assigned for execution or isolation of a quantum job) in quantum system 101, the next quantum job in the queue, priority levels of quantum jobs in the queue, time utilized to perform quantum jobs, and one or more other factors. For example, after selection of the first quantum job and assignment of qubits, scheduling component 104 can select a second quantum job for simultaneous execution with the first quantum job, wherein the second quantum job has an execution time less than or equal to that of the first quantum job. In one or more embodiments, the creation of groups of quantum jobs for simultaneous execution can be performed ahead of compilation.

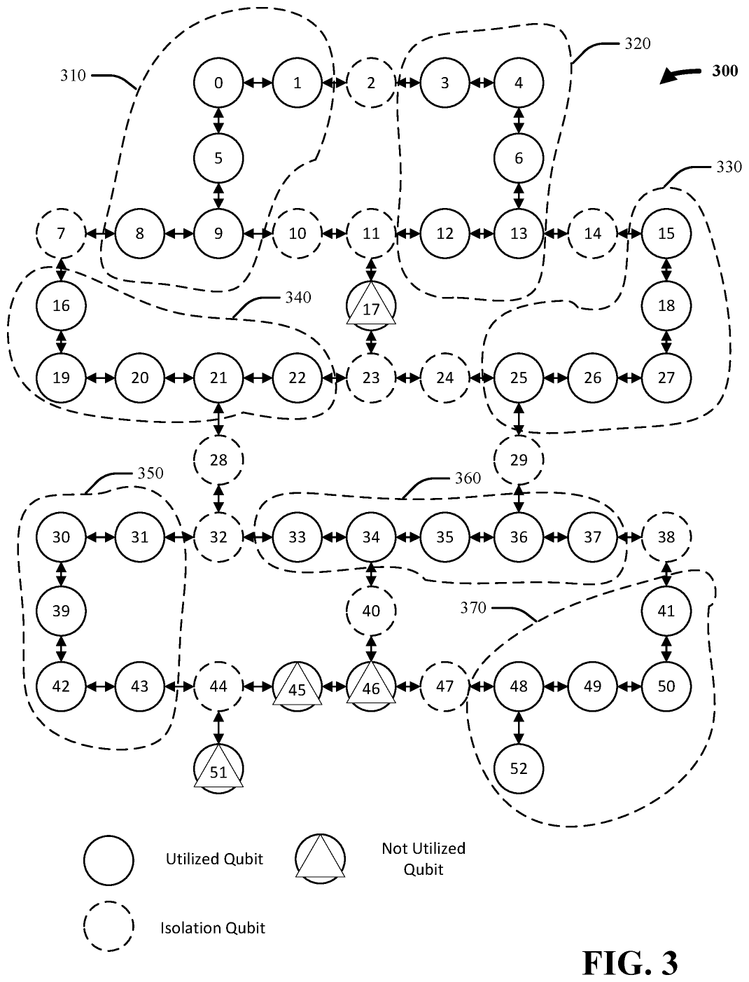

FIG. 3 illustrates a diagram showing qubit utilization of an example quantum processor 300 in accordance with one or more embodiments described herein.

As shown, quantum processor 300 comprises 53 qubits (e.g., qubits 0-52), with some qubits being utilized to perform quantum jobs, some qubits being utilized as isolation qubits, and some qubits not being utilized. For example, quantum processor 300 can be utilized to simultaneous execute seven quantum jobs (e.g., quantum jobs 310-370). As described above in reference to FIG. 1, scheduling component 104 can determine sets of qubits to execute quantum jobs and sets of idle qubits which isolate qubits utilized to execute different quantum jobs from one and other. For example, for quantum job 310, scheduling component 104 can assign qubits 0, 1, 5, 8 and 9 for execution of quantum job 310. Isolation component 110 can then assign qubits 2, 7, 10 and 11 as idle qubits that isolate qubits 0, 1, 5, 8 and 9 from qubits that are not assigned to quantum job 310. Once qubits have been assigned for execution and isolation of quantum job 310, further qubits can be assigned for execution and isolation of further quantum jobs. For example, scheduling component 104 can assign qubits 3, 4, 6, 12 and 13 for execution of quantum job 320 and then isolation component 110 can assign qubits to isolate qubits 3, 4, 6, 12 and 13. It should be appreciated that in some cases, qubits can be assigned to isolate multiple quantum jobs. For example, qubit 2 isolates quantum job 310 and quantum job 320 from one and other. It should be appreciated that while FIG. 3 illustrates an embodiment wherein isolation qubits are determined using a coupling map, the physical layout of the qubits can be considered as well. For example, qubits may be arranged on a physical quantum processor where they are close enough to cause crosstalk, even though they do not appear next to one and other on a coupling map. Accordingly, isolation component 110 can assign qubits as isolation qubits based on the physical layout of a quantum processor in addition to through a coupling map. Furthermore, it should be appreciate that while FIG. 3 illustrates the use of single idle qubits to isolate quantum jobs, in one or more embodiments multiple idle qubits can be utilized to isolate various quantum jobs from one and other. For example, multiple idle qubits can be utilized to isolate quantum jobs based on entity input, calibration data from the quantum processor, the physical layout of the quantum processor, and/or a specified level of importance or one or more quantum jobs.

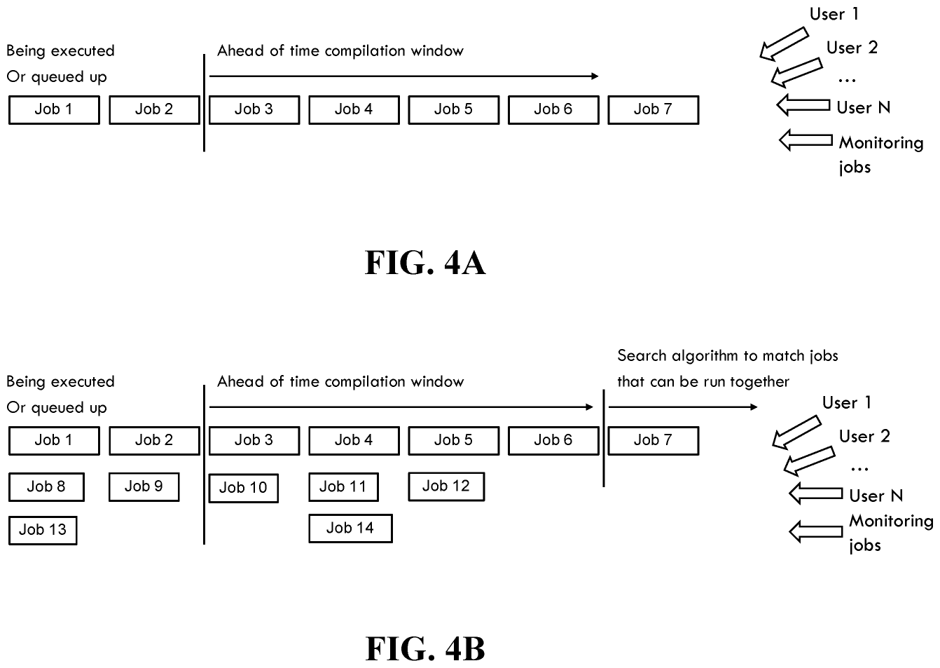

FIGS. 4A and 4B illustrate a comparison of single quantum scheduling and quantum scheduling for simultaneous execution as described herein.

FIG. 4A illustrates single quantum job execution scheduling. For example, as shown, FIG. 4A comprises a single row of quantum jobs, where Job 1 is executed by itself while Job 2 is being queued up for future execution, and Jobs 3-7 are awaiting scheduling for execution.

FIG. 4B illustrates simultaneous quantum job execution scheduling in accordance with one or more embodiments described herein. For example, as shown FIG. 4B comprises multiple rows of quantum jobs that can be executed simultaneously. As shown, Job 1, Job 8 and Job 13 are being executed simultaneously, while Job 2 and 9 are being queued up for simultaneous execution after the execution of Job 1, Job 8 and Job 13. As shown, these jobs can be submitted by one or more entities (e.g., User 1-N and monitoring jobs) and can be scheduled in groups for simultaneous execution during the ahead of time compilation window. For example, scheduling component 104 and isolation component 110 can schedule multiple quantum jobs for simultaneous execution as described above in reference to FIG. 1.

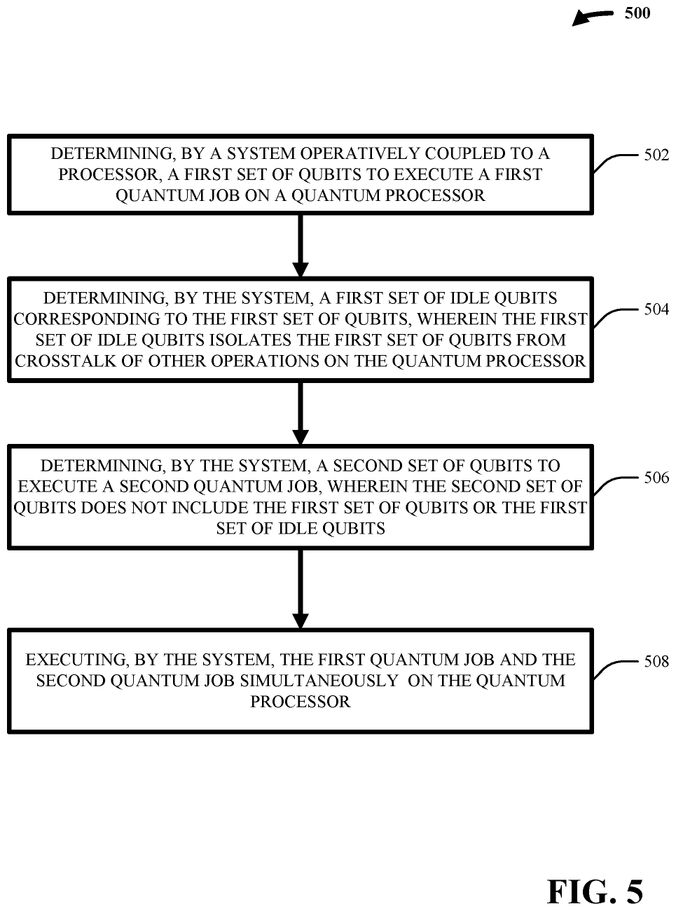

FIG. 5 illustrates a flow diagram of an example, non-limiting, computer-implemented method 500 that can facilitate scheduling of quantum jobs for simultaneous execution in accordance with one or more embodiments described herein.

At 502, method 500 can comprise determining, by a system (e.g., quantum job scheduling system 102 and/or scheduling component 104) operatively coupled to a processor (e.g., processor 106) a first set of qubits to execute a first quantum job on a quantum processor (e.g., quantum system 101). For example, as described above in relation to FIG. 1, scheduling component 104 can determine a group of quantum jobs to execute simultaneously based on factors such as execution time, which qubits require to execute certain quantum jobs, job priority and other factors. Scheduling component 104 can then assign qubits to a first set of qubits which will be utilized to execute the first quantum job.

At 504, method 500 can comprise determining, by the system (e.g., quantum job scheduling system 102 and/or isolation component 110), a first set of idle qubits corresponding to the first set of qubits, wherein the first set of idle qubits isolates the first set of qubits from crosstalk of other operations on the quantum processor.

At 506, method 500 can comprise determining, by the system (e.g., quantum job scheduling system 102 and/or scheduling component 104), a second set of qubits to execute a second quantum job, wherein the second set of qubits does not include the first set of qubits or the first set of idle qubits.

At 508, method 500 can comprise executing, by the system (e.g., quantum job scheduling system 102 and/or quantum system 101) the first quantum job and the second quantum job simultaneously on the quantum processor.

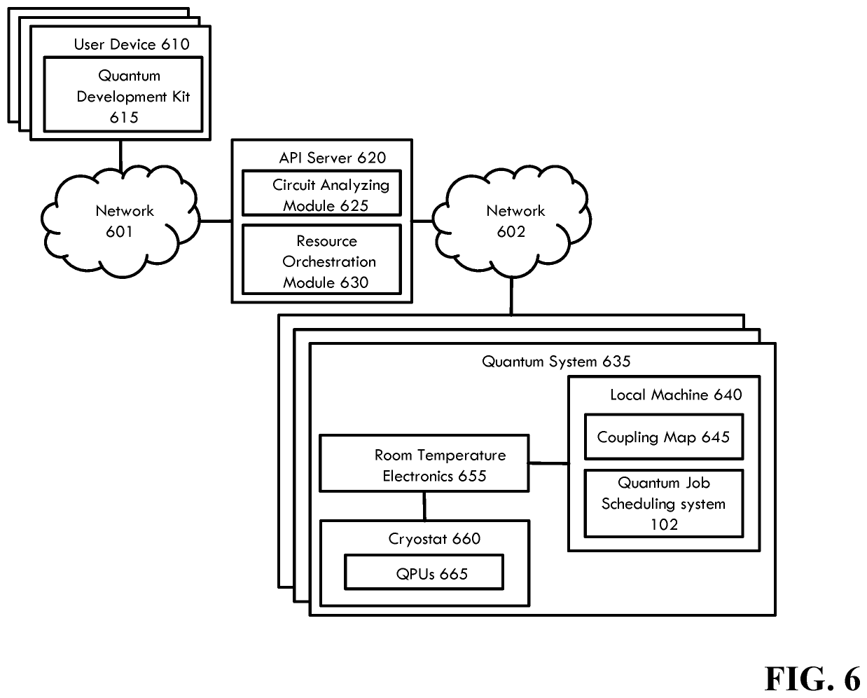

FIG. 6 illustrates a block diagram of a cloud network system 600 that can facilitate scheduling and simultaneous execution of quantum circuits in accordance with one or more embodiments described herein.

As shown, system 600 can comprise a user device 610 connected to an API server 620 via network 601. API server 620 is further connected to quantum system 635 via network 602. User device 610 can be any device that can allow a user to connect to the network. Quantum development kit 615 can allow entities to build and run quantum applications and jobs using quantum software (e.g., Q#, Qiskit, Cirq, etc.). Circuit analyzing module 625 can analyze quantum jobs received from user device 610 and can utilize resource orchestration module 630 to determine which of the one or more quantum systems 635 is suited to perform the quantum job. The quantum job can then be added to a queue for the specific quantum system. Information provided by the circuit analyzing module 625 and/or the resource orchestration module 630 can further be used by scheduling component 104 of FIG. 1 in order to schedule one or more quantum jobs for simultaneous execution.

Quantum system 635 can comprise local machine 640, room temperature electronics 655 and cryostat 660. Local machine 640 can contain the networking and support hardware that allows quantum system 635 to communicate over network 602 and can comprise coupling map 645 and quantum job scheduling system 102. Coupling map 645 can comprise an adjacency matrix that specifies how the qubits of quantum processing unit 665 are connected. In one or more embodiments, local machine 640 can additionally comprise a map of the physical layout of QPUs 665 in addition to or in place of coupling map 645. Quantum job scheduling system 102 can scheduling multiple jobs for simultaneous execution as more fully described above in reference to FIG. 1. In some embodiments, quantum job scheduling system 102 can additionally or alternatively be located on API server 620. Room temperature electronics 655 are the supporting classical computing hardware that interface with quantum processor 665 to set up and execute the desired quantum jobs based on the scheduling provided by quantum job scheduling system 102. Cryostat 660 can comprise the structure that provides cooling, electrical shielding, and communication lines for signals between room temperature electronics 655 and quantum processor 665.

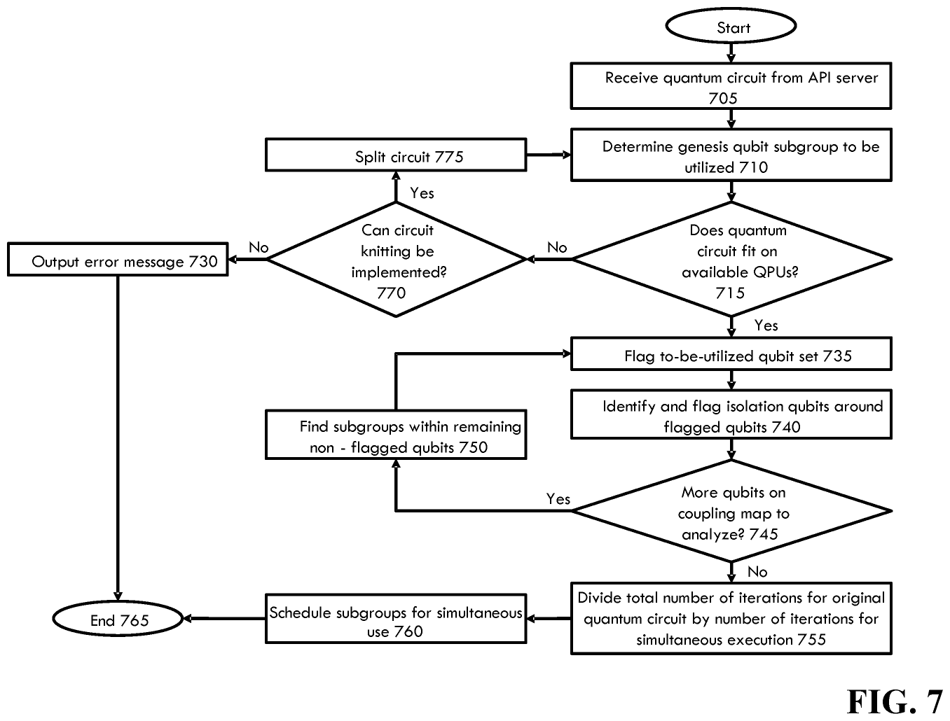

FIG. 7 illustrates a flow diagram of an example, non-limiting, computer-implemented method 700 that can facilitate scheduling of quantum jobs for simultaneous execution in accordance with one or more embodiments described herein.

At 705, method 700 can comprise receiving, by a system (e.g., system 600 and/or quantum job scheduling system 102) a quantum circuit or quantum job from an API server (e.g., API server 620). In one or more embodiments, a number of iterations to run the circuit or quantum job can also be received.

At 710, method 700 can comprise determining, by the system (e.g., quantum job scheduling system and/or scheduling component 104) a genesis qubit subgroup for the quantum job or circuit. As utilized herein, genesis qubit subgroup can refer to the number of qubits and connections needed to execute the highest priority quantum circuit or job in the queue. In one or more embodiments, the genesis qubit subgroup can be determined utilizing methods that select optimum sets of qubits to use for the first quantum job or circuit based on factors such as calibration data, gate fidelity, decoherence time, and/or other factors.

At 715, method 700 can comprise determining, by the system (e.g., local machine 640 and/or quantum job scheduling system 102) if the quantum circuit or job will fit on a quantum processor (e.g., QPU 665) based on the determined genesis qubit subgroup. For example, the genesis subgroup may contain a number of qubits or gates that is larger than that available on QPU 665. In response to a “NO” determination, method 700 can proceed to step 770. In response to a “YES” determination, method 700 can proceed to step 735.

At 770, method 700 can comprise determining, by the system, (e.g., local machine 640 and/or quantum job scheduling system 102) if the quantum circuit or job can be executed using circuit knitting. Circuit knitting can refer to any process by which a larger quantum circuit or job is portioned into smaller portions that are then connected together by quantum simulation. In response to a “YES” determination, method 700 can proceed to step 775 where the quantum circuit or job is portioned into smaller sections. Method 700 can then return to step 710 to determine the genesis qubit subgroups for the circuit partitions. In response to a “NO” determination, method 700 can proceed to step 730 to output an error message and end at step 765.

At step 735, method 700 can comprise flagging or determining, by the system (e.g., quantum job scheduling system 102 and/or scheduling component 104) a to-be-utilized qubit set for the quantum circuit or job. For example, as described above in reference to FIG. 1, for a first quantum job, scheduling component 104 can identify a first set of qubits that are used to execute the quantum job.

At step 740, method 700 can comprise identifying and flagging, by the system (e.g., quantum job scheduling system 102 and/or isolation component 110) isolation qubits around the qubits flagged in step 735. For example, as described above in reference to FIG. 1, isolation component 110 can determine a first set of idle qubits corresponding to the first set of qubits that isolate the first set of qubits from crosstalk of other operations on the quantum processor.

At step 745, method 700 can comprise determining, by the system (e.g., quantum job scheduling system 102 and/or isolation component 110 on local machine 640 or API server 620) if there are more qubits on the coupling map to analyze. For example, if there are more qubits available (e.g., a “YES” determination) to run additional iterations or copies of the quantum circuit or job (e.g., Case 1 described above in reference to FIG. 2A), method 700 can proceed to step 750 to find qubit subgroups within the remaining non-flagged (qubits used for execution of a circuit and qubits used for isolation) qubits and then return to step 735 to determine additional qubit sets to execute copies or iterations of the quantum job. If there is not space available to run more iterations of the quantum circuit or job (e.g., a “NO” determination), method 700 can proceed to step 755.

At step 755, method 700 can comprise dividing, by the system (e.g., quantum job scheduling system 102 and/or scheduling component 104) the total number of iterations the quantum circuit or job is specified to run for by the number of iterations scheduled for simultaneous execution. For example, if a quantum job is specified to be executed 1000 times and four copies of the quantum job are scheduled for simultaneous execution during a single quantum processor cycle, then four simultaneous copies can be executed 250 times for a total of 1000 iterations.

At step 760, method 700 can comprise scheduling, by the system (e.g., quantum job scheduling system 102 and/or scheduling component 104) for simultaneous use or execution on the quantum processor.

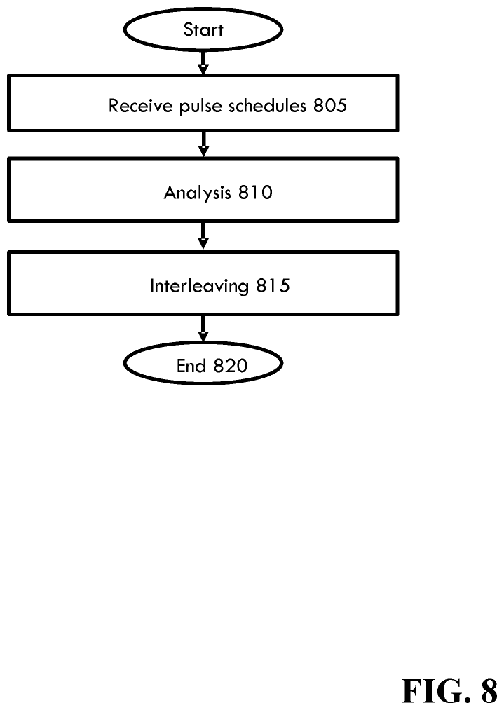

FIG. 8 illustrates a flow diagram of an example, non-limiting, computer-implemented method 800 that can facilitate scheduling of pulses for simultaneous quantum job execution in accordance with one or more embodiments described herein. Repetitive description of like elements employed in other embodiments described herein is omitted for sake of brevity.

At 805, method 800 can comprise receiving, by a system (e.g., local machine 640, room temperature electronics 655, and/or quantum job scheduling system 102), pulse schedules for one or more scheduled quantum jobs. For example, after a group of quantum jobs are scheduled for simultaneous execution by scheduling component 104, pulse schedules for each of the quantum jobs can be generated. These schedules can indicate in what order and the timing of when pulses are applied in order to operate a quantum processor or system.

At 810, method 800 can comprise analyzing, by the system, (e.g., local machine 640, room temperature electronics 655, and/or quantum job scheduling system 102) the received pulse schedules. For example, this analysis can comprise extracting a drive channel map and signal parameters for the selected quantum processor or system, and analyzing the pulse widths, duration and other operations features of the channel map in order to find temporal gaps between pulses for different quantum jobs that are to be run simultaneously.

At 815, method 800 can comprise interleaving, by the system (e.g., local machine 640, room temperature electronics 655, and/or quantum job scheduling system 102), the received pulse schedules into a single pulse schedule. For example, based on the characteristics identified by the analysis and identified gaps in the pulse schedules, the multiple pulse schedules can be interleaved with pulses from one pulse schedule being scheduled for execution during gaps in other pulse schedules. Accordingly, a single unified pulse schedule can be generated through the interleaving of the multiple individual pulse schedules.

A practical application of quantum job scheduling system 102 is that it allows for simultaneous execution of multiple quantum jobs, thereby improving the speed at which multiple quantum jobs can be performed, while also decreasing the overall number of cycles that a quantum processor needs to complete multiple quantum jobs. For example, by simultaneously executing multiple copies of the same quantum job (e.g., Case 1 of FIG. 2A), quantum jobs that call for execution of multiple iterations can be completed in less quantum processor cycles. In another example, by simultaneously executing different multiple quantum jobs, multiple quantum jobs can be completed in fewer cycles when compared to other quantum processors.

It is to be appreciated that quantum job scheduling system 102 can utilize various combinations of electrical components, mechanical components, and circuitry that cannot be replicated in the mind of a human or performed by a human as the various operations that can be executed by quantum job scheduling system 102 and/or components thereof as described herein are operations that are greater than the capability of a human mind. For instance, the amount of data processed, the speed of processing such data, or the types of data processed by quantum job scheduling system 102 over a certain period of time can be greater, faster, or different than the amount, speed, or data type that can be processed by a human mind over the same period of time. In another example, a human mind is not capable of performing quantum operations. According to several embodiments, quantum job scheduling system 102 can also be fully operational towards performing one or more other functions (e.g., fully powered on, fully executed, and/or another function) while also performing the various operations described herein. It should be appreciated that such simultaneous multi-operational execution is beyond the capability of a human mind. It should be appreciated that quantum job scheduling system 102 can include information that is impossible to obtain manually by an entity, such as a human user. For example, the type, amount, and/or variety of information included in quantum job scheduling system 102, such as quantum states of qubits, can be more complex than information obtained manually by an entity, such as a human user.

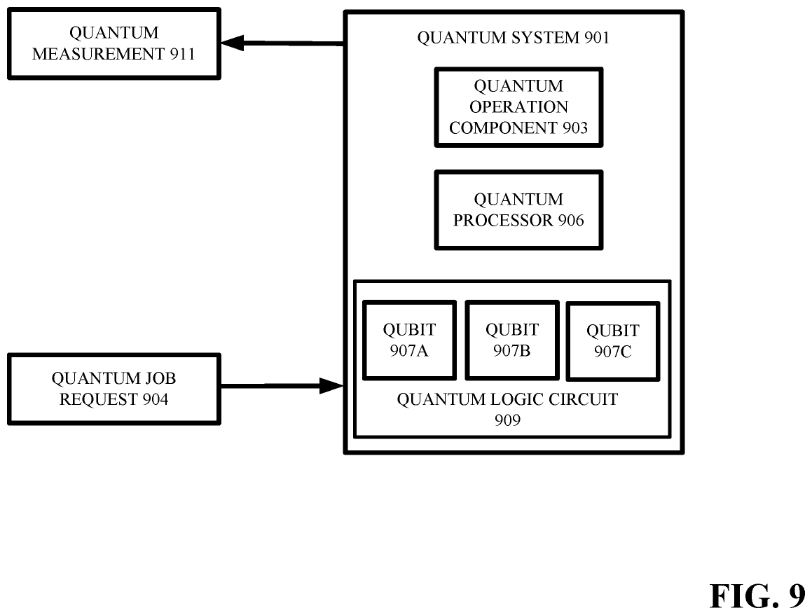

Turning generally to FIG. 9, one or more embodiments described herein can include one or more devices, systems and/or apparatuses that can facilitate executing one or more quantum operations to facilitate output of one or more quantum results. For example, FIG. 9 illustrates a block diagram of an example, non-limiting system 900 that can complete the execution of a quantum job.

The quantum system 901 (e.g., quantum computer system, superconducting quantum computer system and/or the like) can employ quantum algorithms and/or quantum circuitry, including computing components and/or devices, to perform quantum operations and/or functions on input data to produce results that can be output to an entity. The quantum circuitry can comprise quantum bits (qubits), such as multi-bit qubits, physical circuit level components, high level components and/or functions. The quantum circuitry can comprise physical pulses that can be structured (e.g., arranged and/or designed) to perform desired quantum functions and/or computations on data (e.g., input data and/or intermediate data derived from input data) to produce one or more quantum results as an output. The quantum results, e.g., quantum measurement 911, can be responsive to the quantum job request 904 (e.g., the compact operations schedule produced by scheduling component 104) and associated input data and can be based at least in part on the input data, quantum functions and/or quantum computations.

In one or more embodiments, the quantum system 901 can comprise one or more quantum components, such as a quantum operation component 903, a quantum processor 906 and a quantum logic circuit 909 comprising one or more qubits (e.g., qubits 907A, 907B and/or 907C), also referred to herein as qubit devices 907A, 907B and 907C. The quantum processor 906 can be any suitable processor, such as being capable of controlling qubit coherence and the like. The quantum processor 906 can generate one or more instructions for controlling the one or more processes of the quantum operation component 903.

The quantum operation component 903 that can obtain (e.g., download, receive, search for and/or the like) a quantum job request 904 requesting execution of one or more quantum programs. The quantum operation component 903 can determine one or more quantum logic circuits, such as the quantum logic circuit 909, for executing the quantum program. The request 904 can be provided in any suitable format, such as a text format, binary format and/or another suitable format. In one or more embodiments, the request 904 can be received by a component other than a component of the quantum system 901, such as a by a component of a classical system coupled to and/or in communication with the quantum system 901.

The quantum operation component 903 can perform one or more quantum processes, calculations and/or measurements for operating one or more quantum circuits on the one or more qubits 907A, 907B and/or 907C. For example, the quantum operation component 903 can operate one or more qubit effectors, such as qubit oscillators, harmonic oscillators, pulse generators and/or the like to cause one or more pulses to stimulate and/or manipulate the state(s) of the one or more qubits 907A, 907B and/or 907C comprised by the quantum system 901. That is, the quantum operation component 903, such as in combination with the quantum processor 906, can execute operation of a quantum logic circuit on one or more qubits of the circuit (e.g., qubit 907A, 907B and/or 907C). The quantum operation component 903 can output one or more quantum job results, such as one or more quantum measurements 999, in response to the quantum job request 904.

It will be appreciated that the following description(s) refer(s) to the operation of a single quantum program from a single quantum job request. However, it also will be appreciated that one or more of the processes described herein can be scalable, such as execution of one or more quantum programs and/or quantum job requests in parallel with one another.

In one or more embodiments, the non-limiting system 900 can be a hybrid system and thus can include both one or more classical systems, such as a quantum program implementation system, and one or more quantum systems, such as the quantum system 901. In one or more other embodiments, the quantum system 901 can be separate from, but function in combination with, a classical system.

In such case, one or more communications between one or more components of the non-limiting system 900 and a classical system can be facilitated by wired and/or wireless means including, but not limited to, employing a cellular network, a wide area network (WAN) (e.g., the Internet), and/or a local area network (LAN). Suitable wired or wireless technologies for facilitating the communications can include, without being limited to, wireless fidelity (Wi-Fi), global system for mobile communications (GSM), universal mobile telecommunications system (UMTS), worldwide interoperability for microwave access (WiMAX), enhanced general packet radio service (enhanced GPRS), third generation partnership project (3GPP) long term evolution (LTE), third generation partnership project 2 (3GPP2) ultra mobile broadband (UMB), high speed packet access (HSPA), Zigbee and other 802.XX wireless technologies and/or legacy telecommunication technologies, BLUETOOTH®, Session Initiation Protocol (SIP), ZIGBEE®, RF4CE protocol, WirelessHART protocol, 6LoWPAN (Ipv6 over Low power Wireless Area Networks), Z-Wave, an ANT, an ultra-wideband (UWB) standard protocol and/or other proprietary and/or non-proprietary communication protocols.

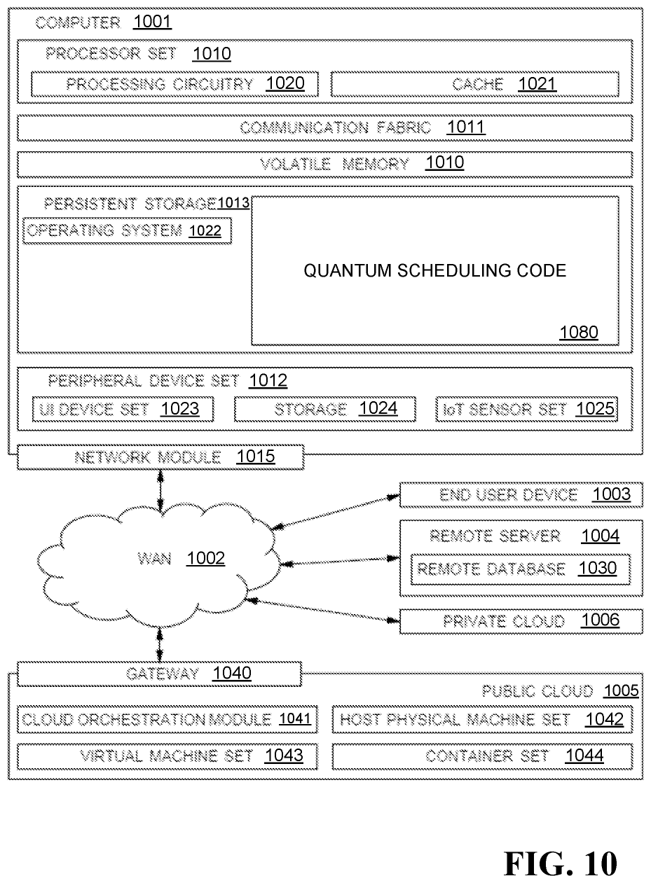

FIG. 10 and the following discussion are intended to provide a brief, general description of a suitable computing environment 1000 in which one or more embodiments described herein at FIGS. 1-8 can be implemented. For example, various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks can be performed in reverse order, as a single integrated step, concurrently or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium can be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 1000 contains an example of an environment for the execution of at least some of the computer code involved in performing the inventive methods, such as translation of an original source code based on a configuration of a target system by the quantum scheduling code 1080. In addition to block 1080, computing environment 1000 includes, for example, computer 1001, wide area network (WAN) 1002, end user device (EUD) 1003, remote server 1004, public cloud 1005, and private cloud 1006. In this embodiment, computer 1001 includes processor set 1010 (including processing circuitry 1020 and cache 1021), communication fabric 1011, volatile memory 1010, persistent storage 1013 (including operating system 1022 and block 1080, as identified above), peripheral device set 1012 (including user interface (UI), device set 1023, storage 1024, and Internet of Things (IoT) sensor set 1025), and network module 1015. Remote server 1004 includes remote database 1030. Public cloud 1005 includes gateway 1040, cloud orchestration module 1041, host physical machine set 1042, virtual machine set 1043, and container set 1044.

COMPUTER 1001 can take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 1030. As is well understood in the art of computer technology, and depending upon the technology, performance of a computer-implemented method can be distributed among multiple computers and/or between multiple locations. On the other hand, in this presentation of computing environment 1000, detailed discussion is focused on a single computer, specifically computer 1001, to keep the presentation as simple as possible. Computer 1001 can be located in a cloud, even though it is not shown in a cloud in FIG. 10. On the other hand, computer 1001 is not required to be in a cloud except to any extent as can be affirmatively indicated.

PROCESSOR SET 1010 includes one, or more, computer processors of any type now known or to be developed in the future. Processing circuitry 1020 can be distributed over multiple packages, for example, multiple, coordinated integrated circuit chips. Processing circuitry 1020 can implement multiple processor threads and/or multiple processor cores. Cache 1021 is memory that is located in the processor chip package(s) and is typically used for data or code that should be available for rapid access by the threads or cores running on processor set 1010. Cache memories are typically organized into multiple levels depending upon relative proximity to the processing circuitry. Alternatively, some, or all, of the cache for the processor set can be located “off chip.” In some computing environments, processor set 1010 can be designed for working with qubits and performing quantum computing.

Computer readable program instructions are typically loaded onto computer 1001 to cause a series of operational steps to be performed by processor set 1010 of computer 1001 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 1021 and the other storage media discussed below. The program instructions, and associated data, are accessed by processor set 1010 to control and direct performance of the inventive methods. In computing environment 1000, at least some of the instructions for performing the inventive methods can be stored in block 1080 in persistent storage 1013.

COMMUNICATION FABRIC 1011 is the signal conduction path that allows the various components of computer 1001 to communicate with each other. Typically, this fabric is made of switches and electrically conductive paths, such as the switches and electrically conductive paths that make up busses, bridges, physical input/output ports and the like. Other types of signal communication paths can be used, such as fiber optic communication paths and/or wireless communication paths.

VOLATILE MEMORY 1010 is any type of volatile memory now known or to be developed in the future. Examples include dynamic type random access memory (RAM) or static type RAM. Typically, the volatile memory is characterized by random access, but this is not required unless affirmatively indicated. In computer 1001, the volatile memory 1010 is located in a single package and is internal to computer 1001, but, alternatively or additionally, the volatile memory can be distributed over multiple packages and/or located externally with respect to computer 1001.

PERSISTENT STORAGE 1013 is any form of non-volatile storage for computers that is now known or to be developed in the future. The non-volatility of this storage means that the stored data is maintained regardless of whether power is being supplied to computer 1001 and/or directly to persistent storage 1013. Persistent storage 1013 can be a read only memory (ROM), but typically at least a portion of the persistent storage allows writing of data, deletion of data and re-writing of data. Some familiar forms of persistent storage include magnetic disks and solid-state storage devices. Operating system 1022 can take several forms, such as various known proprietary operating systems or open-source Portable Operating System Interface type operating systems that employ a kernel. The code included in block 1080 typically includes at least some of the computer code involved in performing the inventive methods.

PERIPHERAL DEVICE SET 1012 includes the set of peripheral devices of computer 1001. Data communication connections between the peripheral devices and the other components of computer 1001 can be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 1023 can include components such as a display screen, speaker, microphone, wearable devices (such as goggles and smart watches), keyboard, mouse, printer, touchpad, game controllers, and haptic devices. Storage 1024 is external storage, such as an external hard drive, or insertable storage, such as an SD card. Storage 1024 can be persistent and/or volatile. In some embodiments, storage 1024 can take the form of a quantum computing storage device for storing data in the form of qubits. In embodiments where computer 1001 is required to have a large amount of storage (for example, where computer 1001 locally stores and manages a large database) then this storage can be provided by peripheral storage devices designed for storing large amounts of data, such as a storage area network (SAN) that is shared by multiple, geographically distributed computers. IoT sensor set 1025 is made up of sensors that can be used in Internet of Things applications. For example, one sensor can be a thermometer and another sensor can be a motion detector.

NETWORK MODULE 1015 is the collection of computer software, hardware, and firmware that allows computer 1001 to communicate with other computers through WAN 1002. Network module 1015 can include hardware, such as modems or Wi-Fi signal transceivers, software for packetizing and/or de-packetizing data for communication network transmission, and/or web browser software for communicating data over the internet. In some embodiments, network control functions and network forwarding functions of network module 1015 are performed on the same physical hardware device. In other embodiments (for example, embodiments that utilize software-defined networking (SDN)), the control functions and the forwarding functions of network module 1015 are performed on physically separate devices, such that the control functions manage several different network hardware devices. Computer readable program instructions for performing the inventive methods can typically be downloaded to computer 1001 from an external computer or external storage device through a network adapter card or network interface included in network module 1015.

WAN 1002 is any wide area network (for example, the internet) capable of communicating computer data over non-local distances by any technology for communicating computer data, now known or to be developed in the future. In some embodiments, the WAN can be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 1003 is any computer system that is used and controlled by an end user (for example, a customer of an enterprise that operates computer 1001) and can take any of the forms discussed above in connection with computer 1001. EUD 1003 typically receives helpful and useful data from the operations of computer 1001. For example, in a hypothetical case where computer 1001 is designed to provide a recommendation to an end user, this recommendation would typically be communicated from network module 1015 of computer 1001 through WAN 1002 to EUD 1003. In this way, EUD 1003 can display, or otherwise present, the recommendation to an end user. In some embodiments, EUD 1003 can be a client device, such as thin client, heavy client, mainframe computer and/or desktop computer.

REMOTE SERVER 1004 is any computer system that serves at least some data and/or functionality to computer 1001. Remote server 1004 can be controlled and used by the same entity that operates computer 1001. Remote server 1004 represents the machine(s) that collect and store helpful and useful data for use by other computers, such as computer 1001. For example, in a hypothetical case where computer 1001 is designed and programmed to provide a recommendation based on historical data, then this historical data can be provided to computer 1001 from remote database 1030 of remote server 1004.

PUBLIC CLOUD 1005 is any computer system available for use by multiple entities that provides on-demand availability of computer system resources and/or other computer capabilities, especially data storage (cloud storage) and computing power, without direct active management by the scale. The direct and active management of the computing resources of public cloud 1005 is performed by the computer hardware and/or software of cloud orchestration module 1041. The computing resources provided by public cloud 1005 are typically implemented by virtual computing environments that run on various computers making up the computers of host physical machine set 1042, which is the universe of physical computers in and/or available to public cloud 1005. The virtual computing environments (VCEs) typically take the form of virtual machines from virtual machine set 1043 and/or containers from container set 1044. It is understood that these VCEs can be stored as images and can be transferred among and between the various physical machine hosts, either as images or after instantiation of the VCE. Cloud orchestration module 1041 manages the transfer and storage of images, deploys new instantiations of VCEs and manages active instantiations of VCE deployments. Gateway 1040 is the collection of computer software, hardware and firmware allowing public cloud 1005 to communicate through WAN 1002.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 1006 is similar to public cloud 1005, except that the computing resources are only available for use by a single enterprise. While private cloud 1006 is depicted as being in communication with WAN 1002, in other embodiments a private cloud can be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1005 and private cloud 1006 are both part of a larger hybrid cloud. The embodiments described herein can be directed to one or more of a system, a method, an apparatus and/or a computer program product at any possible technical detail level of integration. The computer program product can include a computer readable storage medium (or media) having computer readable program instructions thereon for causing a processor to carry out aspects of the one or more embodiments described herein. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a superconducting storage device and/or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon and/or any suitable combination of the foregoing. A computer readable storage medium, as used herein, is not to be construed as being transitory signals per se, such as radio waves and/or other freely propagating electromagnetic waves, electromagnetic waves propagating through a waveguide and/or other transmission media (e.g., light pulses passing through a fiber-optic cable), and/or electrical signals transmitted through a wire.

Computer readable program instructions described herein can be downloaded to respective computing/processing devices from a computer readable storage medium and/or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the one or more embodiments described herein can be assembler instructions, instruction-set-architecture (ISA) instructions, machine instructions, machine dependent instructions, microcode, firmware instructions, state-setting data, configuration data for integrated circuitry, and/or source code and/or object code written in any combination of one or more programming languages, including an object oriented programming language such as Smalltalk, C++ or the like, and/or procedural programming languages, such as the “C” programming language and/or similar programming languages. The computer readable program instructions can execute entirely on a computer, partly on a computer, as a stand-alone software package, partly on a computer and/or partly on a remote computer or entirely on the remote computer and/or server. In the latter scenario, the remote computer can be connected to a computer through any type of network, including a local area network (LAN) and/or a wide area network (WAN), and/or the connection can be made to an external computer (for example, through the Internet using an Internet Service Provider). In one or more embodiments, electronic circuitry including, for example, programmable logic circuitry, field-programmable gate arrays (FPGA) and/or programmable logic arrays (PLA) can execute the computer readable program instructions by utilizing state information of the computer readable program instructions to personalize the electronic circuitry, in order to perform aspects of the one or more embodiments described herein.

Aspects of the one or more embodiments described herein are described with reference to flowchart illustrations and/or block diagrams of methods, apparatus (systems), and computer program products according to one or more embodiments described herein. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general-purpose computer, special purpose computer and/or other programmable data processing apparatus to produce a machine, such that the instructions, which execute via the processor of the computer or other programmable data processing apparatus, can create means for implementing the functions/acts specified in the flowchart and/or block diagram block or blocks. These computer readable program instructions can also be stored in a computer readable storage medium that can direct a computer, a programmable data processing apparatus and/or other devices to function in a particular manner, such that the computer readable storage medium having instructions stored therein can comprise an article of manufacture including instructions which can implement aspects of the function/act specified in the flowchart and/or block diagram block or blocks. The computer readable program instructions can also be loaded onto a computer, other programmable data processing apparatus and/or other device to cause a series of operational acts to be performed on the computer, other programmable apparatus and/or other device to produce a computer-implemented process, such that the instructions which execute on the computer, other programmable apparatus and/or other device implement the functions/acts specified in the flowchart and/or block diagram block or blocks.

The flowcharts and block diagrams in the figures illustrate the architecture, functionality and/or operation of possible implementations of systems, computer-implementable methods and/or computer program products according to one or more embodiments described herein. In this regard, each block in the flowchart or block diagrams can represent a module, segment and/or portion of instructions, which comprises one or more executable instructions for implementing the specified logical function. In one or more alternative implementations, the functions noted in the blocks can occur out of the order noted in the Figures. For example, two blocks shown in succession can be executed substantially concurrently, and/or the blocks can sometimes be executed in the reverse order, depending upon the functionality involved. It will also be noted that each block of the block diagrams and/or flowchart illustration, and/or combinations of blocks in the block diagrams and/or flowchart illustration, can be implemented by special purpose hardware-based systems that can perform the specified functions and/or acts and/or carry out one or more combinations of special purpose hardware and/or computer instructions.

While the subject matter has been described above in the general context of computer-executable instructions of a computer program product that runs on a computer and/or computers, those skilled in the art will recognize that the one or more embodiments herein also can be implemented at least partially in parallel with one or more other program modules. Generally, program modules include routines, programs, components and/or data structures that perform particular tasks and/or implement particular abstract data types. Moreover, the aforedescribed computer-implemented methods can be practiced with other computer system configurations, including single-processor and/or multiprocessor computer systems, mini-computing devices, mainframe computers, as well as computers, hand-held computing devices (e.g., PDA, phone), and/or microprocessor-based or programmable consumer and/or industrial electronics. The illustrated aspects can also be practiced in distributed computing environments in which tasks are performed by remote processing devices that are linked through a communications network. However, one or more, if not all aspects of the one or more embodiments described herein can be practiced on stand-alone computers. In a distributed computing environment, program modules can be located in both local and remote memory storage devices.

As used in this application, the terms “component,” “system,” “platform” and/or “interface” can refer to and/or can include a computer-related entity or an entity related to an operational machine with one or more specific functionalities. The entities described herein can be either hardware, a combination of hardware and software, software, or software in execution. For example, a component can be, but is not limited to being, a process running on a processor, a processor, an object, an executable, a thread of execution, a program and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system and/or across a network such as the Internet with other systems via the signal). As another example, a component can be an apparatus with specific functionality provided by mechanical parts operated by electric or electronic circuitry, which is operated by a software and/or firmware application executed by a processor. In such a case, the processor can be internal and/or external to the apparatus and can execute at least a part of the software and/or firmware application. As yet another example, a component can be an apparatus that provides specific functionality through electronic components without mechanical parts, where the electronic components can include a processor and/or other means to execute software and/or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter described herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit and/or device comprising, but not limited to, single-core processors; single-processors with software multithread execution capability; multi-core processors; multi-core processors with software multithread execution capability; multi-core processors with hardware multithread technology; parallel platforms; and/or parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, and/or any combination thereof designed to perform the functions described herein. Further, processors can exploit nano-scale architectures such as, but not limited to, molecular and quantum-dot based transistors, switches and/or gates, in order to optimize space usage and/or to enhance performance of related equipment. A processor can be implemented as a combination of computing processing units.

Herein, terms such as “store,” “storage,” “data store,” data storage,” “database,” and substantially any other information storage component relevant to operation and functionality of a component are utilized to refer to “memory components,” entities embodied in a “memory,” or components comprising a memory. Memory and/or memory components described herein can be either volatile memory or nonvolatile memory or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory and/or nonvolatile random-access memory (RAM) (e.g., ferroelectric RAM (FeRAM). Volatile memory can include RAM, which can act as external cache memory, for example. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM) and/or Rambus dynamic RAM (RDRAM). Additionally, the described memory components of systems and/or computer-implemented methods herein are intended to include, without being limited to including, these and/or any other suitable types of memory.

What has been described above includes mere examples of systems and computer-implemented methods. It is, of course, not possible to describe every conceivable combination of components and/or computer-implemented methods for purposes of describing the one or more embodiments, but one of ordinary skill in the art can recognize that many further combinations and/or permutations of the one or more embodiments are possible. Furthermore, to the extent that the terms “includes,” “has,” “possesses,” and the like are used in the detailed description, claims, appendices and/or drawings such terms are intended to be inclusive in a manner similar to the term “comprising” as “comprising” is interpreted when employed as a transitional word in a claim.

The descriptions of the various embodiments have been presented for purposes of illustration but are not intended to be exhaustive or limited to the embodiments described herein. Many modifications and variations will be apparent to those of ordinary skill in the art without departing from the scope and spirit of the described embodiments. The terminology used herein was chosen to best explain the principles of the embodiments, the practical application and/or technical improvement over technologies found in the marketplace, and/or to enable others of ordinary skill in the art to understand the embodiments described herein.

What is claimed is:

1. A system comprising:
a memory that stores computer executable components;
a processor that executes computer executable components stored in the memory, wherein the computer executable components comprise:
a scheduling component that determines a first set of qubits to execute a first quantum job on a quantum processor and a second set of qubits to execute a second quantum job, wherein the second set of qubits does not include the first set of qubits or a first set of idle qubits; and
an isolation component that determines the first set of idle qubits, wherein the first set of idle qubits isolates the first set of qubits from crosstalk of other operations on the quantum processor.

2. The system of claim 1, wherein the scheduling component further schedules the first quantum job and the second quantum job for simultaneous execution on the quantum processor.

3. The system of claim 1, wherein the first quantum job and the second quantum job comprise copies of identical quantum jobs.

4. The system of claim 3, wherein the scheduling component further receives a number of iterations to execute the identical quantum jobs and schedules the copies of the identical quantum jobs for simultaneous execution on the quantum processor for the number of iterations divided by a number of copies of the identical quantum jobs.

5. The system of claim 1, wherein the first quantum job and the second quantum job comprise different quantum jobs.

6. The system of claim 1, wherein at least one of the first quantum job or the second quantum job comprises a monitoring job.

7. The system of claim 5, wherein the second quantum job comprises a runtime less than or equal to a runtime of the first quantum job.

8. A computer implemented method comprising:
determining, by a system operatively coupled to a processor, a first set of qubits to execute a first quantum job on a quantum processor;
determining, by the system, a first set of idle qubits corresponding to the first set of qubits, wherein the first set of idle qubits isolates the first set of qubits from crosstalk of other operations on the quantum processor; and
determining, by the system, a second set of qubits to execute a second quantum job, wherein the second set of qubits does not include the first set of qubits or the first set of idle qubits.

9. The computer implemented method of claim 8, further comprising:
executing, by the system, the first quantum job and the second quantum job simultaneously on the quantum processor.

10. The computer implemented method of claim 8, wherein the first quantum job and the second quantum job comprise copies of identical quantum jobs.

11. The computer implemented method of claim 10, further comprising:
receiving, by the system, a number of iterations to execute the identical quantum jobs; and
scheduling, by the system, the copies of the identical quantum jobs for simultaneous execution on the quantum processor for the number of iterations divided by a number of the copies of the identical quantum jobs.

12. The computer implemented method of claim 8, wherein the first quantum job and the second quantum job comprise different quantum jobs.

13. The computer implemented method of claim 12, wherein at least one of the first quantum job or the second quantum job comprises a monitoring job.

14. The computer implemented method of claim 12, wherein the second quantum job comprises a runtime less than or equal to a runtime of the first quantum job.

15. The computer implemented method of claim 8, further comprising:
determining, by the system, one or more additional sets of idle qubits, wherein a set of idle qubits of the one or more additional sets of idle qubits isolates the second set of qubits from crosstalk of other operations on the quantum processor; and
determining, by the system, one or more additional sets of qubits to execute one or more additional quantum jobs, wherein the one or more additional sets of qubits does not include the first set of qubits, the first set of idle qubits, the second set of qubits, or the one or more additional sets of idle qubits.

16. The computer implemented method of claim 8, wherein the first set of qubits and the second set of qubits are determined based on at least one of performance history of the quantum processor, coherence times, gate fidelity and calibration data.

17. A computer program product, comprising a computer readable storage medium having program instructions embodied therewith, the program instructions executable by a processor to cause the processor to:
determine, by the processor, a first set of qubits to execute a first quantum job on a quantum processor;
determine, by the processor, a first set of idle qubits corresponding to the first set of qubits, wherein the first set of idle qubits isolates the first set of qubits from crosstalk of other operations on the quantum processor; and
determine, by the processor, a second set of qubits to execute a second quantum job, wherein the second set of qubits does not include the first set of qubits or the first set of idle qubits.

18. The computer program product of claim 17, wherein the program instructions are further executable by the processor to cause the processor to:
schedule, by the processor, the first quantum job and the second quantum job for simultaneous execution on the quantum processor.

19. The computer program product of claim 17, wherein the first set of qubits and the second set of qubits are determined based on at least one of performance history of the quantum processor, coherence times, gate fidelity and calibration data.

20. The computer program product of claim 17, wherein the program instructions are further executable by the processor to cause the processor to:
determine, by the processor, one or more additional sets of idle qubits, wherein a set of idle qubits of the one or more additional sets of idle qubits isolates the second set of qubits from crosstalk of other operations on the quantum processor; and
determine, by the processor, one or more additional sets of qubits to execute one or more additional quantum jobs, wherein the one or more additional sets of qubits does not include the first set of qubits, the first set of idle qubits, the second set of qubits, or the one or more additional sets of idle qubits.
